(19) United States
(12) Patent Application Publication
(10) Pub. No.: US 2022/0048078 A1
(43) Pub. Date: Feb. 17, 2022

(54) Mirror Cleaning Apparatus

(71) Applicant: Arvin Ramos, Las Vegas, NV (US)

(72) Inventor: Arvin Ramos, Las Vegas, NV (US)

(21) Appl. No.: 17/166,508

(22) Filed: Feb. 3, 2021

Related U.S. Application Data
(60) Provisional application No. 63/066,252, filed on Aug. 16, 2020.

(51) Int. Cl. B08B 3/04; B08B 1/00; B08B 11/02

(52) U.S. Cl. CPC B08B 3/04; B08B 1/002; B08B 11/02; B08B 1/008; B08B 1/006

(57) ABSTRACT

A mirror cleaning apparatus for retaining and cleaning a mirror. The mirror is retained by a pair of vertical rails. A horizontal cleaning bar is movably attached to the pair of vertical rails by a pair of slide components that move the horizontal cleaning bar vertically along the rails. The horizontal cleaning bar houses a plurality of nozzles, brushes, and wipers for cleaning a surface of the mirror as the horizontal cleaning bar moves across the mirror surface. A cleaning fluid distribution component provides and dispenses cleaning fluid to the horizontal cleaning bar. A wastewater collection component collects the used cleaning fluid that is wiped off of the mirror surface by the wipers.

### CROSS-REFERENCE TO RELATED APPLICATION

The present application claims priority to, and the benefit of, U.S. Provisional Application No. 63/066,252, which was filed on Aug. 16, 2020 and is incorporated herein by reference in its entirety.

### FIELD OF THE INVENTION

The present invention relates generally to an apparatus for cleaning a mirror. More specifically, the present invention relates to an automated mirror cleaning apparatus for mirrors mounted on walls. Accordingly, this disclosure makes specific reference thereto the present invention. Nonetheless, it is to be appreciated that aspects of the present invention are also equally applicable to other like applications, devices and methods of manufacture.

### BACKGROUND OF THE INVENTION

By way of background, mirrors are used in every bathroom. Usually, the mirrors are mounted over the wash basin and easily get dirty with water splashes, toothpaste splatter, fingerprints, dust or the like. A dirty mirror makes an otherwise clean bathroom look filthy. Usually, people manually clean the mirrors in the bathrooms using a cleaning solution on the mirror surface and wiping off the solution using a clean piece of cloth. Unfortunately, this often leaves streaks on the mirror and make it appear dirty. The “cleaned” mirrors are frequently left with water spots, streaks, smudges or the like, requiring additional cleaning.

People may also use manual wipers or squeegees to clean mirrors. A cleaning solution or water is sprayed on the mirror surface and then the wiper or squeegees is used to wipe off the cleaning solution, thereby cleaning the mirror surface. Unfortunately, the wiped cleaning solution or dirty water is splashed on the floor or on the wash basin by the wiper leaving other surfaces dirty. The complete cleaning process is manual and requires a lot of user's effort and time.

Currently, solutions available for the cleaning the mirror are manual. Also, standard methods of wiping down the mirror may leave streaks and marks that force additional cleaning. Therefore, there exists a long felt need in the art for an automated mirror cleaning system. There is also a long felt need in the art for a mirror cleaning system which cleans the mirror properly without leaving any streaks or spots on the surface of the mirror. Additionally, there is a long felt need in the art for a mirror cleaner apparatus which requires no manual labor saving user time and effort. Moreover, there is a long felt need in the art for a mirror cleaner which minimize the use of water or cleaning solution for cleaning the mirror. Finally, there is a long felt need in the art for a mirror cleaner which comprises a proper water draining mechanism.

In this manner, the novel mirror cleaning apparatus of the present invention accomplishes all of the forgoing objectives, and provides a relatively quick, easy and convenient solution for cleaning mirrors. A primary feature of the present invention is an apparatus that is mountable and adaptable to a variety of mirrors, especially bathroom mirrors. The mirror cleaning apparatus of the present invention is also user friendly, inasmuch as it is automatic, and does not require the user to put much effort or labor into cleaning the mirror surface and saves the time of the user as well.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a mirror cleaning apparatus. The mirror cleaning apparatus is configured to clean mirrors mounted on a wall. The mirror cleaning apparatus comprises a pair of vertical rails and a horizontal cleaning bar. The horizontal cleaning bar is movably attachable to the pair of vertical rails. Each of the vertical rails comprises a mirror mounting slot. The mirror mounting slots are configured to engage a pair of sides of a mirror and hold the mirror in place within the mirror cleaning apparatus. One or both of the vertical rails may further comprise a valve and an actuation switch.

The mirror cleaning apparatus further comprises a pair of slide components. Each slide component slidably engages one of the pair of rails. The horizontal cleaning bar comprises a pair of ends and a mirror engaging component. Each end is attached to one of the slide components.

The pair of slide components are electrically driven by a motor to move the horizontal cleaning bar vertically along the pair of rails.

The mirror cleaning apparatus further comprises a cleaning fluid distribution component. The cleaning fluid distribution component is in fluid communication with the horizontal cleaning bar and the valve or valves of the vertical rails. The cleaning fluid distribution component is configured to supply the mirror engaging component with a cleaning solution for cleaning a surface of the mirror. The cleaning fluid distribution component may comprise a reservoir for retaining the cleaning solution. The reservoir may be housed within one of the pair of rails, the horizontal cleaning bar, or may be external to the rails and bar. The cleaning fluid distribution component may further comprise a tubing and a pump, both in fluid communication with the reservoir for dispensing the cleaning fluid. The tubing may be retained within one or both rails and extend into the horizontal cleaning bar.

The mirror engaging component is positioned to engage the front surface of the mirror. The mirror engaging component comprises a plurality of nozzles. The plurality of nozzles span a length of the mirror engaging component and are supplied with the cleaning fluid by the tubing. The mirror engaging component further comprises a plurality of brushes. The plurality of brushes similarly span the length of the mirror engaging component and are configured to shrub the front surface of the mirror. The mirror engaging component further comprises a plurality of wipers. The plurality of wipers similarly span the length of the mirror engaging component and are configured to squeegee the front surface of the mirror once scrubbed.

Once activated, the pump discharges a small amount of cleaning solution through the nozzles onto the surface of the mirror. The brushes then rotate to clean the wet front surface of the mirror as the horizontal cleaning bar moves upward along the front surface of the mirror. Once the horizontal cleaning bar reaches the top, the wipers are activated to engage the front surface of the mirror and the horizontal cleaning bar travels back down the mirror. The wipers ensures the mirror is wiped clean for future use.

The mirror cleaning apparatus further comprises a wastewater collection component. The wastewater collection component is attached to a bottom of each of the pair of vertical rails and extends generally horizontally between the rails. The wastewater collection component comprises a reservoir and a drain tubing. The wastewater collection component is positioned to capture the runoff of the used cleaning solution as it if squeegeed off of the front surface of the mirror by the plurality of wipers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the mirror cleaning apparatus of the present invention in accordance with the disclosed architecture;

FIG. 2 illustrates a perspective view of one potential embodiment of the mirror cleaning apparatus of the present invention engaging a mirror in accordance with the disclosed architecture;

FIG. 3 illustrates a perspective view of the mirror retained by one potential embodiment of the mirror cleaning apparatus of the present invention in accordance with the disclosed architecture;

FIG. 4A illustrates a cutaway view of one of a pair of vertical rails, a horizontal cleaning bar, and a cleaning fluid distribution component of one potential embodiment of the mirror cleaning apparatus of the present invention in accordance with the disclosed architecture;

FIG. 4B illustrates a cutaway view of one of the pair of vertical rails, the horizontal cleaning bar, and the cleaning fluid distribution component of one potential embodiment of the mirror cleaning apparatus of the present invention in accordance with the disclosed architecture;

FIG. 5 illustrates a cutaway view of the horizontal cleaning bar of one potential embodiment of the mirror cleaning apparatus of the present invention in accordance with the disclosed architecture; and

FIG. 6 illustrates a perspective view of one potential embodiment of the mirror cleaning apparatus of the present invention cleaning a surface of the mirror in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an automated mirror cleaning system. There is also a long felt need in the art for a mirror cleaning system which cleans the mirror properly without leaving any streaks or spots on the surface of the mirror. Additionally, there is a long felt need in the art for a mirror cleaner which requires no manual labor. Further, there is a long felt need in the art for an automatic mirror cleaning solution which saves user time and effort. Moreover, there is a long felt need in the art for a mirror cleaner which minimize the use of water or cleaning solution for cleaning the mirror. There is a long felt need in the art for a mirror cleaner which comprises a proper water draining mechanism. Finally, there is a long felt need in the art for a mirror cleaner which is effective and convenient to the user.

The present invention, in one exemplary embodiment, is an automatic mirror cleaner system for cleaning a mirror mounted on a wall. The mirror cleaner comprises a horizontal bar secured between two vertical rails. The horizontal bar comprises an angle bar featuring brushes, valves and wiper components powered by a motor. The motor discharges a small amount of water via the valve, allowing the brushes to clean the mirror as the horizontal bar travels up the mirror. The mirror cleaner may comprise two micro solenoid valves attached at the bottom of each of the vertical rails, for controlling the flow of water supply to the wipers on the horizontal bar. Once the device reaches the top, the wiper is activated and the bar travels back down. The wiper ensures the mirror is wiped clean for future use. The invention offers a novel and effective solution for cleaning mirrors automatically.

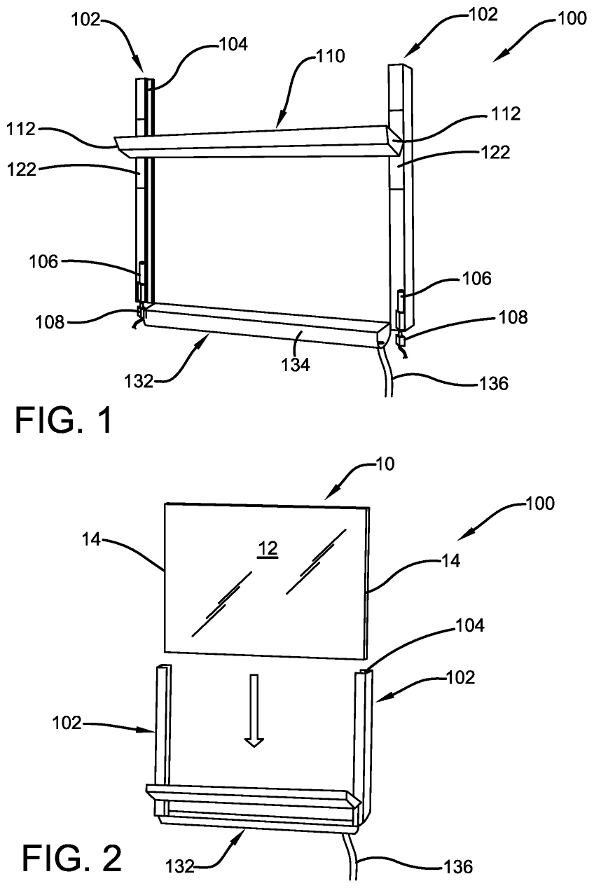

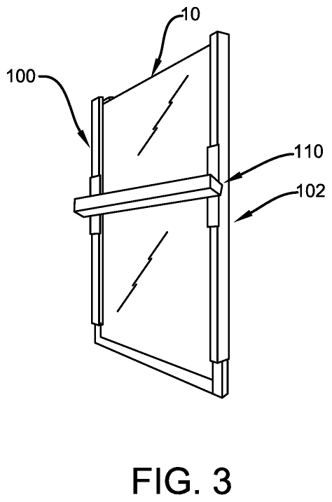

Referring initially to the drawings, FIGS. 1-6 illustrate a mirror cleaning apparatus 100. The mirror cleaning apparatus 100 is configured to clean a mirror 10 mounted on a wall, such as a bathroom mirror. The mirror cleaning apparatus 100 comprises a pair of vertical rails 102 and a horizontal cleaning bar 110. The pair of vertical rails 102 and the horizontal bar 110 may be manufactured from metal such as stainless steel, aluminum, or the like, or rigid plastic. The horizontal cleaning bar 110 is movably attachable to the pair of vertical rails 102. Each of the vertical rails 102 comprises a mirror mounting slot 104. The mirror mounting slots 104 are grooves or channels configured to engage a pair of sides 14 of the mirror 10 and hold the mirror 10 in place within the mirror cleaning apparatus 100. The pair of vertical rails 102 and the horizontal cleaning bar 110 may be adjustable in size and may be extended or retracted to accommodate mirrors of different sizes. In an embodiment, pair of vertical rails 102 and the horizontal cleaning bar 110 may have a telescopic structure and may be adjusted in length. The horizontal cleaning bar 110 is movably mounted between the pair of vertical rails 102, such that the horizontal cleaning bar 110 can slide upwards or downwards over the vertical rails 102 for cleaning a front surface 12 of the mirror 10.

To position the mirror 10 within the mirror cleaning apparatus 100, the pair of sides 14 of the mirror 10 are positioned to engage the mirror mounting slots 104 as illustrated in FIG. 2. Once the pair of sides 14 of the mirror 10 are inserted into the vertical rails 102 respectively, the user slides the mirror 10 in a downward direction to property mount the mirror 10 into the mirror cleaning apparatus 100. The mirror mounting slots 104 enables the mirror cleaning apparatus 100 to firmly hold the mirror 10 for cleaning. The mirror 10 is mounted in a manner such that the front surface 12 of the mirror 10 is towards the horizontal cleaning bar 110 of the mirror cleaning system 100 so as to provide effective cleaning of the front surface 12.

One or both vertical rails 102 may further comprise a valve 106 and an actuation switch 108. The valves 106 may be micro solenoid valves configured to control the flow of cleaning solution into the mirror cleaning apparatus 100. The actuation switches 108 are in electrical communication with the valves 106 and are used to activate the valves 106 to supply the horizontal cleaning bar 110 with the cleaning solution. The valves 106 are compact in design and have extremely low power consumption with a low-leakage design. Further, the micro design of the valves 106 has a reduced overall footprint and can be easily accommodated inside the structure of the mirror cleaning apparatus 100.

The actuation switches 108 are electrically connected to an external or internal power source 140. The power source 140 may be a rechargeable battery or an electrical plug for connecting to a power grid. A user may activate the actuation switches 108 to turn ON the mirror cleaner 100 or may deactivate the actuation switches 108 to turn OFF the mirror cleaning apparatus 100.

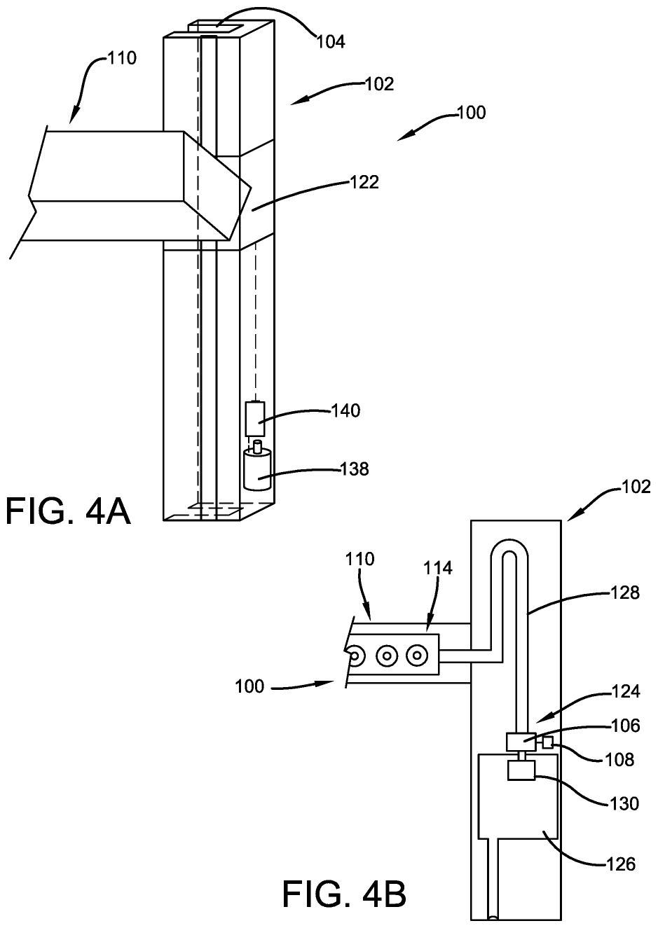

As illustrated in FIG. 4A, the mirror cleaning apparatus 100 further comprises a pair of slide components 122. Each slide component 122 slidably engages one of the pair of rails 102. The horizontal cleaning bar 110 comprises a pair of ends 112 and a mirror engaging component 114. Each end 112 is attached to one of the slide components 122. The pair of slide components 122 are electrically driven by a motor 138 to move the horizontal cleaning bar 110 vertically along the pair of rails 102 as illustrated in FIG. 6.

The mirror cleaning apparatus 100 further comprises a cleaning fluid distribution component 124. The cleaning fluid distribution component 124 is in fluid communication with the horizontal cleaning bar 110 and the valve or valves 106 of the vertical rails 102. The cleaning fluid distribution component 124 is configured to supply the mirror engaging component 114 with a cleaning solution for cleaning the front surface 12 of the mirror 10.

As illustrated in FIG. 4B, the cleaning fluid distribution component 124 may comprise a reservoir 126 for retaining the cleaning solution. The reservoir 126 may be housed within one of the pair of rails 102, the horizontal cleaning bar 110, or may be located external to the rails 102 and bar 110. The cleaning fluid distribution component 124 may further comprise a tubing 128 and a pump 130 The tubing 128 and the pump 130 are both in fluid communication with the reservoir 126 for dispensing the cleaning fluid. The tubing 128 may be retained within one or both rails 102 and extends into the horizontal cleaning bar 110. The tubing 128 connects the solenoid valves 106 to the mirror engaging component 114 for supplying and dispensing cleaning solution through the horizontal cleaning bar 110 and cleaning the mirror surface 12.

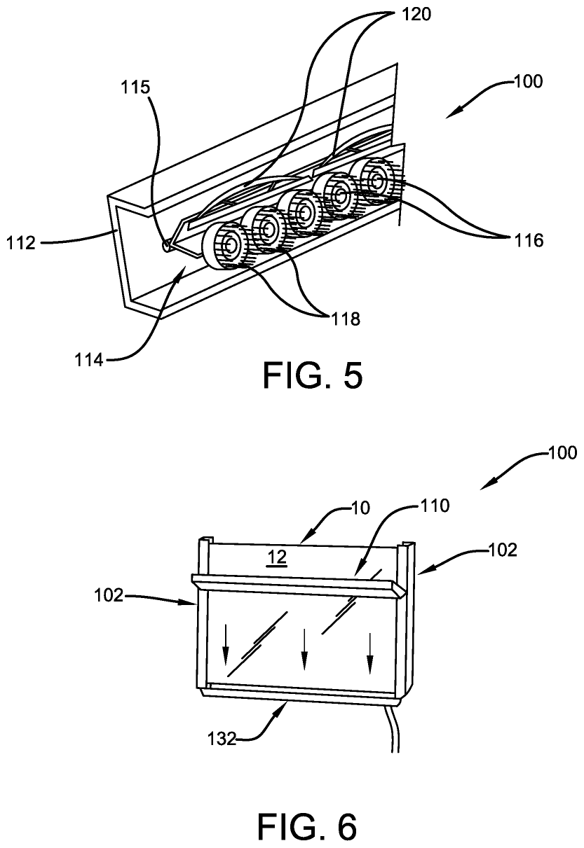

The mirror engaging component 114 is positioned to engage the front surface 12 of the mirror 10. As illustrated in FIG. 5, the mirror engaging component 114 is an angle rail. A cleaning bar attachment corner 115 of the mirror engaging component 114 is movably attached via a hinge or toggle to a mirror facing side of the horizontal cleaning bar 110. The mirror engaging component 114 further comprises a plurality of nozzles 116. The plurality of nozzles 116 span a length of the mirror engaging component 114 and are supplied with the cleaning fluid by the tubing 128 of the cleaning fluid distribution component 124.

The mirror engaging component 114 further comprises a plurality of brushes 118. The plurality of brushes 118 similarly span the length of the mirror engaging component 114 and are configured to shrub the front surface 12 of the mirror 10. The plurality of brushes 118 are attached to one of the outer ends of the mirror engaging component 114. As the horizontal cleaning bar 110 moves upward along the front surface 12 of the mirror 10, the cleaning bar attachment corner 115 of the mirror engaging component 114 toggles so that the plurality of brushes 118 contact the mirror 10.

The mirror engaging component 114 further comprises a plurality of wipers 120. The plurality of wipers 120 similarly span the length of the mirror engaging component 114 and are configured to squeegee the front surface 12 of the mirror 10 once scrubbed by the plurality of brushes 118. The plurality of wipers 120 are attached to the other outer end of the mirror engaging component 114. As the horizontal cleaning bar 110 moves downward along the front surface 12 of the mirror 10, the cleaning bar attachment corner 115 of the mirror engaging component 114 toggles so that the plurality of wipers 120 contact the mirror 10 and the plurality of brushes 118 no longer contact the mirror 10.

Once activated, the motor 138 discharges a small amount of cleaning solution through the nozzles 116 onto the surface 12 of the mirror 10. The brushes 118 then rotate or move back and forth to clean the wet front surface 12 of the mirror 10 as the horizontal cleaning bar 110 moves upward along the front surface 12 of the mirror 10 as illustrated in FIG. 6. Once the horizontal cleaning bar 110 reaches the top, the wipers 120 are activated to engage the front surface 12 of the mirror 10 and the horizontal cleaning bar 110 travels back down the mirror 10. The wipers 120 ensures the mirror 10 is wiped clean for future use.

The mirror cleaning apparatus 100 further comprises a wastewater collection component 132. The wastewater collection component 132 is attached to a bottom of each of the pair of vertical rails 102 and extends generally horizontally between the rails 102. The wastewater collection component 132 comprises a reservoir 134 and a drain tubing 136. The wastewater collection component 132 is positioned to capture the runoff of the used cleaning solution as it if squeegeed off of the front surface 12 of the mirror 10 by the plurality of wipers 120.

The mirror cleaning apparatus 100 may be made available in different sizes and colors to accommodate user need and/or preference, and the exact size, measurement, construction and design specifications of the unique mirror cleaning apparatus 100 of the present invention may vary upon manufacturing or the particular material that is used. The mirror cleaning apparatus 100 may further comprise logos, indicia, trademarks, geometric patterns, customizable colors and fonts, embroidery and prints and/or images on the surface of the rails 102, the horizontal cleaning bar 110 or other components.

Notwithstanding the forgoing, the mirror cleaning apparatus 100 of the present invention can be of any suitable size and configuration as is known in the art without affecting the overall concept of the invention, provided that it accomplishes the above stated objectives. One of ordinary skill in the art will appreciate that the size, configuration and material of the mirror cleaning apparatus 100 as shown in the FIGS. are for illustrative purposes only, and that many other sizes and shapes of the mirror cleaning apparatus 100 are well within the scope of the present disclosure. Although the dimensions of the mirror cleaning apparatus 100 are important design parameters for user convenience, the mirror cleaning apparatus 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A mirror cleaning apparatus comprising:
a pair of vertical rails;
a horizontal cleaning bar movably attached to the pair of vertical rails, the horizontal cleaning bar comprising a mirror engaging component;
a cleaning fluid distribution component in fluid communication with the horizontal cleaning bar.

2. The mirror cleaning apparatus of claim 1, wherein each of the vertical rails comprises a mirror mounting slot.

3. The mirror cleaning apparatus of claim 1, wherein one of the vertical rails comprises a valve in fluid communication with the cleaning fluid distribution component and an actuation switch for activating the valve.

4. The mirror cleaning apparatus of claim 1, wherein the mirror engaging component comprises a plurality of nozzles in fluid communication with the cleaning fluid distribution component.

5. The mirror cleaning apparatus of claim 1, wherein the mirror engaging component comprises a plurality of brushes.

6. The mirror cleaning apparatus of claim 1, wherein the mirror engaging component comprises a plurality of wipers.

7. The mirror cleaning apparatus of claim 1 further comprising a wastewater collection component attached to a bottom of each of the pair of vertical rails.

8. The mirror cleaning apparatus of claim 1, wherein the cleaning fluid distribution component comprises a pump.

9. The mirror cleaning apparatus of claim 1 further comprising a rechargeable battery.

10. A mirror cleaning apparatus for cleaning a mirror comprising:
a pair of vertical rails, each comprising a valve and an actuation switch;
a horizontal cleaning bar movably attached to the pair of vertical rails, the horizontal cleaning bar comprising a mirror engaging component; and
a cleaning fluid distribution component in fluid communication with the horizontal cleaning bar and each valve in each vertical rail.

11. The mirror cleaning apparatus of claim 10, wherein each of the vertical rails further comprises a mirror mounting slot.

12. The mirror cleaning apparatus of claim 10, wherein the mirror engaging component comprises a plurality of nozzles in fluid communication with the cleaning fluid distribution component.

13. The mirror cleaning apparatus of claim 10, wherein the mirror engaging component comprises a plurality of brushes.

14. The mirror cleaning apparatus of claim 10, wherein the mirror engaging component comprises a plurality of wipers.

15. The mirror cleaning apparatus of claim 10 further comprising a wastewater collection component attached to a bottom of each of the pair of vertical rails.

16. The mirror cleaning apparatus of claim 10, wherein the cleaning fluid distribution component comprises a tubing connecting each valve in each vertical rail to the mirror engaging component of the horizontal cleaning bar.

17. The mirror cleaning apparatus of claim 10, wherein the cleaning fluid distribution component comprises a reservoir.

18. A mirror cleaning apparatus for cleaning a mirror comprising:
a pair of vertical rails, each comprising a mirror mounting slot, a valve and an actuation switch;
a horizontal cleaning bar comprising a mirror engaging component;
a pair of slide components for moving the horizontal cleaning bar along the pair of vertical rails;
a cleaning fluid distribution component in fluid communication with the horizontal cleaning bar and the pair of vertical rails; and
a wastewater collection component.

19. The mirror cleaning apparatus of claim 18, wherein the mirror engaging component comprises a plurality of nozzles in fluid communication with the cleaning fluid distribution component, a plurality of brushes, and a plurality of wipers.

20. The mirror cleaning apparatus of claim 18, wherein the cleaning fluid distribution component comprises a tubing connecting each valve in each vertical rail to the mirror engaging component of the horizontal cleaning bar.
